(19) United States
(12) Patent Application Publication
(10) Pub. No.: US 2009/0197184 A1
(43) Pub. Date: Aug. 6, 2009

(54) NON-AQUEOUS ELECTROLYTIC SOLUTION BATTERY AND NON-AQUEOUS ELECTROLYTIC SOLUTION COMPOSITION

(75) Inventor: Atsumichi Kawashima, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/362,931

(22) Filed: Jan. 30, 2009

(30) Foreign Application Priority Data
Jan. 31, 2008 (JP) 2008-020656
Jun. 30, 2008 (JP) 2008-170677

(51) Int. Cl. H01M 6/16

(52) U.S. Cl. 429/331

(57) ABSTRACT

A non-aqueous electrolytic solution battery includes a positive electrode, a negative electrode and an electrolytic solution, wherein the non-aqueous electrolytic solution contains two kinds of halogenated cyclic carbonates containing a different halogen element from each other.

### CROSS REFERENCES TO RELATED APPLICATIONS

The present application claims priority to Japanese Patent Application JP 2008-020656 and Japanese Patent Application JP 2008-170677 filed in the Japan Patent Office on Jan. 31, 2008 and Jun. 30, 2008, respectively, the entire contents of which are incorporated herein by reference.

### BACKGROUND

The present application relates to a non-aqueous electrolytic solution composition capable of keeping excellent charge-discharge efficiency while suppressing battery expansion at the time of high-temperature storage and a non-aqueous electrolytic solution battery using the same.

In recent years, a number of portable electronic devices such as camcorders, digital still cameras, cellular phones, personal digital assistants and laptop computers, each achieving a reduction in size and weight, have appeared. As to batteries, in particular, secondary batteries as a portable power source for such electronic devices, intensive studies have been conducted for the purpose of enhancing the energy density.

Above all, lithium ion secondary batteries using carbon for a negative electrode active material, a lithium-transition metal composite oxide for a positive electrode active material and a carbonic ester mixture for an electrolytic solution have been widely put to practical use because they are able to obtain a high energy density as compared with related-art non-aqueous electrolytic solution secondary batteries such as lead batteries and nickel-cadmium batteries. Also, in laminated batteries using an aluminum laminated film for an exterior, since the exterior is thin and lightweight, the amount of an active material can be increased, and the energy density is high.

In these secondary batteries, in order to enhance battery characteristics such as a cycle characteristic, for example, it is proposed to add various additives in a non-aqueous electrolytic solution (see JP-B-7-11967, Japanese Patent No. 3244389, JP-A-5-325985 and JP-A-8-306364).

### SUMMARY

In secondary batteries, though when charge and discharge are repeated, a discharge capacity retention rate is gradually lowered, it is known that the discharge capacity retention rate is enhanced by the addition of fluoroethylene carbonate. However, since the fluoroethylene carbonate has a problem of expansion at the time of high-temperature storage, it could not be added in a large amount in a laminated battery.

On the other hand, chloroethylene carbonate in which chlorine is bonded in place of fluorine of fluoroethylene carbonate is decomposed more easily than fluoroethylene carbonate and forms a thicker film, and therefore, it is free from a problem of the expansion at the time of high-temperature storage. However, there was involved a problem that since the film is thick, the resistance increases, whereby the discharge capacity retention rate is lowered as compared with that at the time of addition of fluoroethylene carbonate.

In view of the foregoing problems, it is desirable to provide a non-aqueous electrolytic solution composition capable of keeping a favorable discharge capacity retention rate at the time of repetition of charge and discharge while suppressing the battery expansion at the time of high-temperature storage and a non-aqueous electrolytic solution battery using the same.

According to an embodiment, it has been found that by containing two kinds of halogenated cyclic carbonates containing a different halogen element from each other in a non-aqueous electrolytic solution, a favorable discharge capacity retention rate can be kept at the time of repetition of charge and discharge while suppressing the expansion at the time of high-temperature storage.

Specifically, according to an embodiment, there are provided the following non-aqueous electrolytic solution secondary battery and non-aqueous electrolytic solution composition.

(1) A non-aqueous electrolytic solution battery including a positive electrode, a negative electrode and a non-aqueous electrolytic solution, wherein the non-aqueous electrolytic solution contains two kinds of halogenated cyclic carbonates containing a different halogen element from each other.

(2) A non-aqueous electrolytic solution composition containing two kinds of halogenated cyclic carbonates containing a different halogen element from each other.

According to the non-aqueous electrolytic solution composition and the non-aqueous electrolytic solution secondary battery of an embodiment, it may be thought that the two kinds of halogenated cyclic carbonates containing a different halogen element from each other, which are contained in the non-aqueous electrolytic solution, form a film having low resistance and high solvent protecting capability on the surface of an electrode. According to this, not only the battery expansion at the time of high-temperature storage is suppressed, but excellent charge-discharge efficiency can be kept.

Additional features and advantages are described herein, and will be apparent from the following Detailed Description and the figures.

### BRIEF DESCRIPTION OF THE FIGURES

FIG. 1 is an exploded perspective view showing a configuration of a non-aqueous electrolytic solution secondary battery according to an embodiment.

FIG. 2 is a cross-sectional view showing a configuration along an I-I line of a wound electrode body as shown in FIG. 1.

### DETAILED DESCRIPTION

Embodiment of the present application are described in detail with reference to the accompanying drawings, but it should not be construed that the present application is limited thereto.

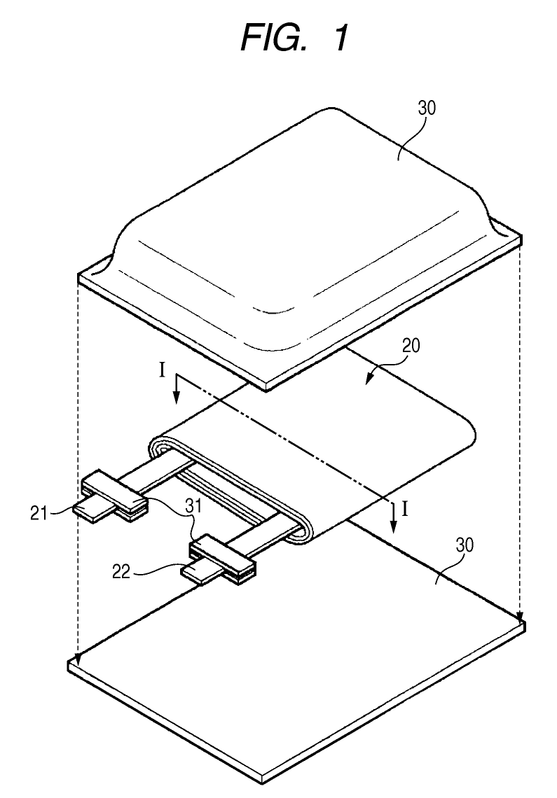

FIG. 1 schematically shows a configuration of a laminate type battery according to an embodiment. This secondary battery is one named as a so-called laminated film type, wherein a wound electrode body 20 having a positive electrode lead 21 and a negative electrode lead 22 installed therein is contained in the inside of an exterior member 30 in a film-like state.

The positive electrode lead 21 and the negative electrode lead 22 are each derived in, for example, the same direction from the inside towards the outside of the exterior member 30. The positive electrode lead 21 and the negative electrode lead 22 are each constituted of a metal material such as aluminum, copper, nickel and stainless steel and formed in a thin plate state or a network state.

The exterior member 30 is constituted of a rectangular aluminum laminated film obtained by sticking, for example, a nylon film, an aluminum foil and a polyethylene film in this order. The exterior member 30 is, for example, provided in such a manner that the polyethylene film side and the wound electrode body 20 are disposed opposing to each other, and respective external edges thereof are brought into intimate contact with each other by fusion or an adhesive. An adhesive film 31 is inserted between the exterior member 30 and each of the positive electrode lead 21 and the negative electrode lead 22 for the purpose of preventing invasion of the outside air. The adhesive film 31 is constituted of a material having adhesiveness to the positive electrode lead 21 and the negative electrode lead 22, such as polyolefin resins, for example, polyethylene, polypropylene, modified polyethylene and modified polypropylene.

The exterior member 30 may also be constituted of a laminated film having other structure, a polymer film such as polypropylene or a metal film in place of the foregoing aluminum laminated film.

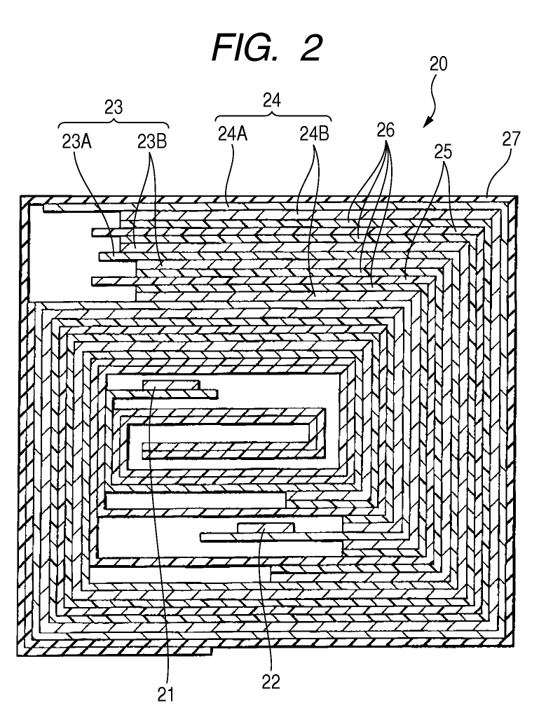

FIG. 2 shows a cross-sectional structure along an I-I line of the wound electrode body 20 as shown in FIG. 1. The wound electrode body 20 is one prepared by laminating and winding a positive electrode 23 and a negative electrode 24 via a separator 25 and an electrolyte layer 26, and an outermost periphery thereof is protected by a protective tape 27.

(Active Material Layer)

The positive electrode 23 has a structure in which a positive electrode active material layer 23B is provided on the both surfaces of a positive electrode collector 23A. The negative electrode 24 has a structure in which a negative electrode active material layer 24B is provided on the both surfaces of a negative electrode collector 24A. The negative electrode active material layer 24B and the positive electrode active material layer 23B are disposed opposing to each other. In the non-aqueous electrolytic solution secondary battery according to the embodiment, it is preferable that the positive electrode active material layer 23B is coated and dried, thereby having a coverage per surface of from 14 to 30 mg/cm²; and it is preferable that the negative electrode active material layer 24B is coated and dried, thereby having a coverage per surface of from 7 to 15 mg/cm².

Each of the positive electrode active material layer 23B and the negative electrode active material layer 24B has a thickness per surface of 40 μm or more, preferably not more than 80 μm, and more preferably in the range of 40 μm or more and not more than 60 μm. When the thickness of the active material layer is 40 μm or more, it is possible to devise to realize a high capacity of the battery. Also, where the thickness of the active material layer is not more than 80 μm, it is possible to make a discharge capacity retention rate at the time of repetition of charge and discharge high.

(Positive Electrode)

The positive electrode collector 23A is constituted of a metal material, for example, aluminum, nickel and stainless steel. The positive electrode active material layer 23B contains, as a positive electrode active material, any one kind or plural kinds of a positive electrode material capable of intercalating and deintercalating lithium and may contain a conductive agent such as carbon materials and a binder such as polyvinylidene fluoride as the need arises.

As the positive electrode material capable of intercalating and deintercalating lithium, lithium composite oxides, for example, lithium cobaltate, lithium nickelate and solid solutions thereof [Li(NiₓCo_{y}Mn_{z})O₂] (wherein values of x, y and z are satisfied with the relationships of 0<x<1, 0<y<1, 0≦z<1, and (x +y+z)=1), and manganese spinel (LiMn₂O₄) and solid solutions thereof [Li(Mn₂₋ᵥNiᵥ)O₄] (wherein a value of v is satisfied with the relationship of v<2); and phosphoric acid compounds having an olivine structure, for example, lithium iron phosphate (LiFePO₄) are preferable. This is because a high energy density is obtainable.

Also, examples of the positive electrode material capable of intercalating and deintercalating lithium include oxides, for example, titanium oxide, vanadium oxide and manganese dioxide; disulfides, for example, iron disulfide, titanium disulfide and molybdenum disulfide; sulfur; and conductive polymers, for example, polyaniline and polythiophene.

(Negative Electrode)

The negative electrode 24 has, for example, a structure in which the negative electrode active material layer 24B is provided on the both surfaces of the negative electrode collector 24A having a pair of opposing surfaces. The negative electrode collector 24A is constituted of a metal material, for example, a copper, nickel and stainless steel.

The negative electrode active material layer 24B contains, as a negative electrode active material, any one kind or plural kinds of a negative electrode material capable of intercalating and deintercalating lithium. This secondary battery is designed such that the charge capacity of the negative electrode material capable of intercalating and deintercalating lithium is larger than the charge capacity of the positive electrode 23 and that a lithium metal is not deposited on the negative electrode 24 on the way of charge.

Examples of the negative electrode material capable of intercalating and deintercalating lithium include carbon materials, for example, hardly graphitized carbon, easily graphitized carbon, graphite, pyrolytic carbons, cokes, vitreous carbons, organic polymer compound burned materials, carbon fibers and active carbon. Of these, examples of the cokes include pitch coke, needle coke and petroleum coke. The organic polymer compound burned material as referred to herein is a material obtained through carbonization by burning a polymer material such as phenol resins and furan resins at an appropriate temperature, and a part thereof is classified into hardly graphitized carbon or easily graphitized carbon.

Also, examples of the polymer material include polyacetylene and polypyrrole. Such a carbon material is preferable because a change in the crystal structure to be generated at the time of charge and discharge is very small, a high charge-discharge capacity can be obtained, and a good cycle characteristic can be obtained. In particular, graphite is preferable because its electrochemical equivalent is large, and a high energy density can be obtained. Also, hardly graphitized carbon is preferable because excellent characteristics are obtainable. Moreover, a material having a low charge-discharge potential, specifically one having a charge-discharge potential close to a lithium metal, is preferable because it is easy to realize a high energy density of the battery.

Also, besides the above-exemplified carbon materials, materials containing silicon, tin or a compound thereof, or an element capable of forming an alloy together with lithium, for example, magnesium, aluminum and germanium may be used as the negative electrode material. Furthermore, a material containing an element capable of forming a composite oxide together with lithium, for example, titanium is considerable.

(Separator)

The separator 25 is one which partitions the positive electrode 23 and the negative electrode 24 from each other and passes a lithium ion therethrough while preventing a short circuit of the current due to contact of the both electrodes. This separator 25 is constituted of a porous membrane made of a synthetic resin, for example, polytetrafluoroethylene, polypropylene and polyethylene, or a porous membrane made of a ceramic and may also have a structure in which plural kinds of such a porous membrane are laminated. The separator 25 is impregnated with, for example, a non-aqueous electrolytic solution which is a liquid electrolyte.

(Non-Aqueous Electrolytic Solution)

The non-aqueous electrolytic solution according to an embodiment contains two kinds of halogenated cyclic carbonates containing a different halogen element from each other. According to this, it may be thought that the discharge capacity retention rate at the time of repetition of charge and discharge can be enhanced while suppressing the expansion at the time of high-temperature storage.

The content of the halogenated cyclic carbonates in the non-aqueous electrolytic solution is preferably not more than 2% by mass, and more preferably 0.6% by mass or more and not more than 2% by mass. This is because when the content of the halogenated cyclic carbonates in the non-aqueous electrolytic solution falls within this range, a higher effect is obtainable.

As the two kinds of halogenated cyclic carbonates containing a different halogen element from each other, a fluorinated cyclic carbonate and a chlorinated cyclic carbonate are suitably exemplified. Examples of the fluorinated cyclic carbonate include 4-fluoro-1,3-dioxolan-2-one(fluoroethylene carbonate) (hereinafter also referred to as “FEC”) [formula (1)], trans-4,5-difluoro-fluoro-1,3-dioxolan-2-one(difluoroethylene carbonate) (hereinafter also referred to as “DFEC”) [formula (2)] and trifluoropropylene carbonate [formula (3)]. Of these, fluoroethylene carbonate is preferable from the viewpoint of the formation of a low-resistance film.

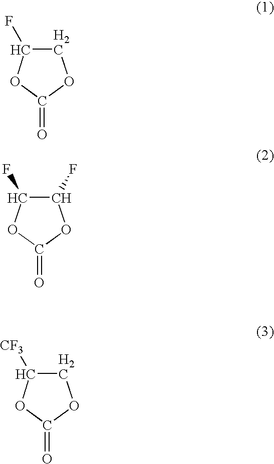

Also, examples of the chlorinated cyclic carbonate include 4-chloro-1,3-dioxolan-2-one(chloroethylene carbonate) (hereinafter also referred to as “ClEC”) [formula (4)] and trichloropropylene carbonate [formula (5)]. Of these, chloroethylene carbonate is preferable from the viewpoint of solvent protecting capability.

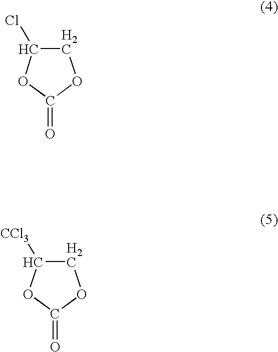

A mass ratio of the fluorinated cyclic carbonate to the chlorinated cyclic carbonate in the non-aqueous electrolytic solution is preferably from 1/1 to 1/10, and more preferably from 1/1 to 1/4. This is because when the mass ratio of the fluorinated cyclic carbonate to the chlorinated cyclic carbonate in the non-aqueous electrolytic solution falls within this range, a film having low resistance and high solvent protecting capability is formed.

It is preferable that the non-aqueous electrolytic solution according to the embodiment further contains lithium tetrafluoroborate (LiBF₄). When lithium tetrafluoroborate is further added in addition to the foregoing two kinds of halogenated cyclic carbonates containing a different halogen element from each other, the expansion at the time of high-temperature storage can be more suppressed. This is because it may be thought that decomposition of the halogenated cyclic carbonates is accelerated by lithium tetrafluoroborate.

The content of lithium tetrafluoroborate in the non-aqueous electrolytic solution is preferably in the range of from 0.05 to 0.5% by mass, and more preferably in the range of from 0.1 to 0.3% by mass. This is because when the content of lithium tetrafluoroborate in the non-aqueous electrolytic solution falls within this range, the halogenated cyclic carbonates can be decomposed due to lithium tetrafluoroborate while suppressing an increase of the resistance. Also, in the case of adding chloroethylene carbonate (CEC) as the halogenated cyclic carbonate, its addition amount is preferably equal to or not more than that of FEC. This is because according to this, an increase of the resistance can be suppressed.

The non-aqueous electrolytic solution in an embodiment further contains a solvent and an electrolyte salt as dissolved in the solvent. The solvent to be used in the non-aqueous electrolytic solution is preferably a high-dielectric solvent having a dielectric constant of 30 or more. This is because according to this, the number of the lithium ion can be increased. The content of the high-dielectric solvent in the non-aqueous electrolytic solution is preferably in the range of from 15 to 50% by mass. This is because when the content of the high-dielectric solvent in the non-aqueous electrolytic solution falls within this range, higher charge-discharge efficiency is obtainable.

Examples of the high-dielectric solvent include cyclic carbonic esters such as vinylene carbonate, ethylene carbonate, propylene carbonate, butylene carbonate and vinyl ethylene carbonate; lactones such as γ-butyrolactone and γ-valerolactone; lactams such as N-methyl-2-pyrrolidone; cyclic carbamic esters such as N-methyl-2-oxazolidinone; and sulfone compounds such as tetramethylene sulfone. In particular, cyclic carbonic esters are preferable; and ethylene carbonate and vinylene carbonate having a carbon-carbon double bond are more preferable. Also, the high-dielectric solvent may be used singly or in admixture of two or more kinds thereof.

As the solvent to be used in the non-aqueous electrolytic solution, it is preferable to use a mixture of the foregoing high-dielectric solvent with a low-viscosity solvent having a viscosity of not more than 1 mPa·s. This is because according to this, high ionic conductivity can be obtained. A ratio (mass ratio) of the low-viscosity solvent relative to the high-dielectric solvent is preferably in the range of from 2/8 to 5/5 in terms of a ratio of the high-dielectric solvent to the low-viscosity solvent. This is because when the ratio of the high-dielectric solvent to the low-viscosity solvent falls within this range, a higher effect is obtainable.

Examples of the low-viscosity solvent include chain carbonic esters such as dimethyl carbonate, diethyl carbonate, ethylmethyl carbonate and methylpropyl carbonate; chain carboxylic acid esters such as methyl acetate, ethyl acetate, methyl propionate, ethyl propionate, methyl butyrate, methyl isobutyrate, methyl trimethylacetate and ethyl trimethylacetate; chain amides such as N,N-dimethylacetamide; chain carbamic esters such as methyl N,N-diethylcarbamate and ethyl N,N-diethylcarbamate; and ethers such as 1,2-dimethoxyethane, tetrahydrofuran, tetrahydropyran and 1,3-dioxolan. Such a low-viscosity solvent may be used singly or in admixture of two or more kinds thereof.

Examples of the electrolyte salt include inorganic lithium salts such as lithium hexafluorophosphate (LiPF₆), lithium tetrafluoroborate (LiBF₄), lithium hexafluoroarsenate (LiAsF₆), lithium hexafluoroantimonate (LiSbF₆), lithium perchlorate (LiClO₄) and lithium tetrachloroaluminate (LiAlCl₄); and lithium salts of a perfluoroalkanesulfonic acid derivative such as lithium trifluoromethanesulfonate (CF₃SO₃Li), lithium bis(trifluoromethanesulfone)imide [(CF₃SO₂)₂NLi], lithium bis(pentafluoroethanesulfone)imide [(C₂F₅SO₂)₂NLi] and lithium tris(trifluoromethanesulfone)methide [(CF₃SO₂)₃CLi]. The electrolyte salt may be used singly or in admixture of two or more kinds thereof. The content of the electrolyte salt in the non-aqueous electrolytic solution is preferably from 6 to 25% by mass.

(Polymer Compound)

The battery in an embodiment may be formed in a gel state by containing a polymer compound which is swollen by the non-aqueous electrolytic solution to become a supporter for supporting the non-aqueous electrolytic solution. This is because by containing the polymer compound which is swollen by the non-aqueous electrolytic solution, high ionic conductivity can be obtained, excellent charge-discharge efficiency is obtainable, and liquid leakage of the battery can be prevented. In the case where a polymer compound is added to the non-aqueous electrolytic solution and used, the content of the polymer compound in the non-aqueous electrolytic solution is preferably in the range of 0.1% by mass or more and not more than 2.0% by mass. Also, in the case where a polymer compound such as polyvinylidene fluoride is coated on the both surfaces of the separator and used, a mass ratio of the non-aqueous electrolytic solution to the polymer compound is preferably in the range of from 50/1 to 10/1. This is because when the mass ratio of the non-aqueous electrolytic solution to the polymer compound falls within this range, higher charge-discharge efficiency is obtainable.

Examples of the polymer compound include ether based polymer compounds such as polyvinyl formal [formula (6)], polyethylene oxide and polyethylene oxide-containing crosslinked material; ester based polymer compounds such as polymethacrylates [formula (7)]; acrylate based polymer compounds; and polymers of vinylidene fluoride such as polyvinylidene fluoride [formula (8)] and a copolymer of vinylidene fluoride and hexafluoropropylene. The polymer compound may be used singly or in admixture of plural kinds thereof. In particular, from the viewpoint of an effect for preventing swelling at the time of high-temperature storage, it is desirable to use a fluorocarbon based polymer compound such as polyvinylidene fluoride.

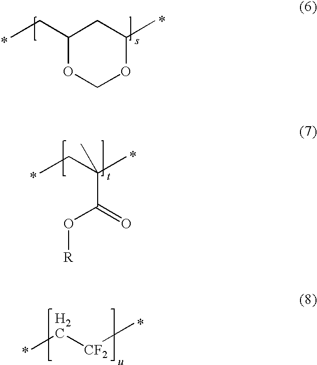

In the foregoing formulae (6) to (8), s, t and u each represents an integer of from 100 to 10,000; and R represents CₓH₂ₓ₊₁O₁ (wherein x represents an integer of from 1 to 8; and y represents an integer of from 0 to 4 and is not more than (x−1)).

(Manufacturing Method)

This secondary battery can be, for example, manufactured in the following manner.

A positive electrode can be, for example, prepared in the following method. First of all, a positive electrode active material, a conductive agent and a binder are mixed to prepare a positive electrode mixture; and this positive electrode mixture is dispersed in a solvent such as N-methyl-2-pyrrolidone to form a positive electrode mixture slurry in a paste state. Subsequently, this positive electrode mixture slurry is coated on the positive electrode collector 23A; and after drying the solvent, compression molding is carried out by using a roll press, etc. to form the positive electrode active material layer 23B. There is thus prepared the positive electrode 23. On that occasion, the positive electrode active material layer 23B is regulated so as to have a thickness of 40 μm or more.

Also, a negative electrode can be, for example, prepared in the following method. First of all, a negative electrode active material containing at least one of silicon and tin as a constitutional element, a conductive agent and a binder are mixed to prepare a negative electrode mixture; and this negative electrode mixture is then dispersed in a solvent such as N-methyl-2-pyrrolidone to form a negative electrode mixture slurry in a paste state. Subsequently, this negative electrode mixture slurry is coated on the negative electrode collector 24A, dried and then subjected to compression molding to form the negative electrode active material layer 24B containing a negative electrode active material particle composed of the foregoing negative electrode active material. There is thus obtained the negative electrode 24. On that occasion, the negative electrode active material layer 24B is regulated so as to have a thickness of 40 μm or more.

Next, a precursor solution containing a non-aqueous electrolytic solution, a polymer compound and a mixed solvent is coated on each of the positive electrode 23 and the negative electrode 24, and the mixed solvent is volatized to form the electrolyte layer 26. Next, the positive electrode lead 21 is installed in the positive electrode collector 23A, and the negative electrode lead 22 is also installed in the negative electrode collector 24A. Subsequently, the positive electrode 23 and the negative electrode 24, on each of which is formed the electrolyte layer 26, are laminated via the separator 25 to form a laminate; this laminate is wound in its longitudinal direction; and the protective tape 27 is bonded to the outermost periphery to form the wound electrode body 20. Thereafter, for example, the wound electrode body 20 is put into the exterior members 30; the external edges of the exterior members 30 are adhered closely and sealed by means of heat fusion. On that occasion, the adhesive film 31 is inserted between each of the positive electrode lead 21 and the negative electrode lead 22 and the exterior body 30. There is thus completed the secondary battery as shown in FIGS. 1 and 2.

Also, this secondary battery may be prepared in the following manner. First of all, as described above, the positive electrode 23 and the negative electrode 24 are prepared; the positive electrode lead 21 and the negative electrode lead 22 are installed in the positive electrode 23 and the negative electrode 24, respectively; the positive electrode 23 and the negative electrode 24 are laminated via the separator 25 and wound; and the protective tape 27 is bonded to the outermost periphery to form a wound body which is a precursor of the wound electrode body 20. Subsequently, this wound body is put between the exterior members 30; and the external edges excluding one side are heat fused to form a bag-like material, whereby the wound body is contained in the inside of the exterior member 30. Subsequently, an electrolyte composition containing a non-aqueous electrolytic solution and a monomer as a raw material of the polymer compound and optionally containing a polymerization initiator or a polymerization inhibitor or the like is prepared and poured into the inside of the exterior member 30; and an opening of the exterior member 30 is then sealed by means of heat fusion. Thereafter, if desired, the monomer is polymerized to form a polymer compound by heating to form the electrolyte layer 26 in a gel state. There is thus assembled the secondary battery as shown in FIGS. 1 and 2.

In this secondary battery, when charge is carried out, for example, a lithium ion is deintercalated from the positive electrode 23 and intercalated in the negative electrode 24 via the non-aqueous electrolytic solution. On the other hand, when discharge is carried out, for example, a lithium ion is deintercalated from the negative electrode 24 and intercalated in the positive electrode 24 via the non-aqueous electrolytic solution.

The present application has been described with reference to the foregoing embodiments, but it should not be construed that the present application is not limited thereto, and various changes and modifications can be made therein. For example, in the foregoing embodiments, the case of using a non-aqueous electrolytic solution as the electrolyte has been described, and the case of using a gel electrolyte having a non-aqueous electrolytic solution supported on a polymer compound has also be described. However, other electrolytes may be used. Examples of other electrolytes include mixtures of an ionically conductive inorganic compound (for example, ionically conductive ceramics, ionically conductive glasses and ionic crystals) and a non-aqueous electrolytic solution; mixtures of other inorganic compound and a non-aqueous electrolytic solution; and mixtures of such an inorganic compound and a gel electrolyte.

Also, in the foregoing embodiments, the battery using lithium as an electrode reactant has been described. However, the present application is applicable to the case of using other alkali metal (for example, sodium (Na) and potassium (K)), an alkaline earth metal (for example, magnesium and calcium (Ca)) or other light metal (for example, aluminum).

Furthermore, in the foregoing embodiments, the so-called lithium ion secondary battery in which the capacity of the negative electrode is expressed by the capacity component due to the intercalation and deintercalation of lithium; and the so-called lithium metal secondary battery in which a lithium metal is used as the negative electrode material, and the capacity of the negative electrode is expressed by the capacity component due to the deposition and dissolution of lithium have been described. However, the present application is similarly applicable to a secondary battery in which by controlling the charge capacity of a negative electrode material capable of intercalating and deintercalating lithium smaller than the charge capacity of a positive electrode, the capacity of the negative electrode includes a capacity component due to the intercalation and deintercalation of lithium and a capacity component due to the deposition and dissolution of lithium and is expressed by the sum thereof.

Moreover, in the foregoing embodiments, the laminate type secondary battery has been specifically referred to and described. However, needless to say, the present application is not limited to the foregoing shape. That is, the present application is applicable to cylindrical batteries, square-shaped batteries and the like. Also, the present application is applicable to not only the secondary batteries but other batteries such as primary batteries.

### EXAMPLES

The present application is described below with reference to the following Examples in an embodiment. It should not be construed that the present application is limited to these Examples, and various changes and modifications can be made therein.

### Examples 1-1 to 1-16 and Comparative Examples 1-1 to 1-6

### Example 1-1

First of all, 94 parts by weight of a lithium/cobalt composite oxide (LiCoO₂) as a positive electrode active material, 3 parts by weight of graphite as a conductive material and 3 parts by weight of polyvinylidene fluoride (PVdF) as a binder were uniformly mixed, to which was then added N-methylpyrrolidone to obtain a positive electrode mixture coating solution. Next, the obtained positive electrode mixture coating solution was uniformly coated on the both surfaces of an aluminum foil having a thickness of 20 μm and dried to form a positive electrode mixture layer of 20 mg/cm² per one surface. This was cut into a shape of 50 mm in width and 300 mm in length to prepare a positive electrode.

Next, 97 parts by weight of graphite as a negative electrode active material and 3 parts by weight of PVdF as a binder were uniformly mixed, to which was then added N-methylpyrrolidone to obtain a negative electrode mixture coating solution. Next, the obtained negative electrode mixture coating solution was uniformly coated on the both surfaces of a copper foil having a thickness of 20 μm as a negative electrode collector and dried to form a negative electrode mixture layer of 10 mg/cm² per one surface. This was cut into a shape of 50 mm in width and 300 mm in length to prepare a negative electrode.

An electrolytic solution was prepared by mixing ethylene carbonate, ethylmethyl carbonate, lithium hexafluorophosphate, fluoroethylene carbonate (FEC) and chloroethylene carbonate (ClEC) in a proportion (mass ratio) of 33.4/51/15/0.5/0.1.

The positive electrode and the negative electrode were laminated via a separator made of a microporous polyethylene film having a thickness of 9 μm and wound up, and then placed in a bag made of an aluminum laminated film. 2 g of the electrolytic solution was poured into this bag, and the bag was heat fused to prepare a laminate type battery. This battery had a capacity of 800 mAh.

This battery was charged for 3 hours under an atmosphere at 23° C. with an upper limit being 4.2 V at 800 mAh and then stored at 90° C. for 4 hours. At that time, a change in the thickness of the battery is expressed as an expansion rate and shown in Table 1. The expansion rate is a value obtained by calculation while the battery thickness before the storage is a denominator, whereas the increased thickness at the time of storage is a numerator. Also, a discharge capacity retention rate at the time of repetition of constant-current discharge with a lower limit being 3.0 V at 800 mAh 300 times after charge for 3 hours under an atmosphere at 23° C. with an upper limit being 4.2 V at 800 mAh is shown in Table 1.

### Examples 1-2, 1-3, 1-5 to 1-7, 1-9, 1-10 and 1-12

Laminate type batteries were prepared in the same manner as in Example 1-1, except for changing the ratio of fluoroethylene carbonate to chloroethylene carbonate in the non-aqueous electrolytic solution as shown in Table 1 and increasing or decreasing the amount of ethylene carbonate in conformity therewith and then evaluated for physical properties. The obtained results are shown in Table 1.

### Examples 1-4, 1-8 and 1-11

Laminate type batteries were prepared in the same manner as in Example 1-1, except for making the ratio of chloroethylene carbonate larger than that of fluoroethylene carbonate in the non-aqueous electrolytic solution and then evaluated for physical properties. The obtained results are shown in Table 1.

### Example 1-13

A laminate type battery was prepared in the same manner as in Example 1-1, except for regulating the total sum of fluoroethylene carbonate and chloroethylene carbonate in the non-aqueous electrolytic solution at 2% by mass or more and then evaluated for physical properties. The obtained results are shown in Table 1.

### Examples 1-14 and 1-15

Laminate type batteries were prepared in the same manner as in Example 1-1, except for mixing difluoroethylene carbonate in place of fluoroethylene carbonate with chloroethylene carbonate in a ratio as shown in Table 1 in the non-aqueous electrolytic solution and then evaluated for physical properties. The obtained results are shown in Table 1.

### Example 1-16

A laminate type battery was prepared in the same manner as in Example 1-14, except for making the ratio of chloroethylene carbonate larger than that of difluoroethylene carbonate in the non-aqueous electrolytic solution and then evaluated for physical properties. The obtained results are shown in Table 1.

### Comparative Examples 1-1 to 1-4

Laminate type batteries were prepared in the same manner as in Example 1-1, except for not mixing chloroethylene carbonate in the non-aqueous electrolytic solution and then evaluated for physical properties. The obtained results are shown in Table 1.

### Comparative Example 1-5

A laminate type battery was prepared in the same manner as in Example 1-14, except for not mixing chloroethylene carbonate in the non-aqueous electrolytic solution and changing the concentration of difluoroethylene carbonate and then evaluated for physical properties. The obtained results are shown in Table 1.

### Comparative Example 1-6

A laminate type battery was prepared in the same manner as in Example 1-1, except for adding neither fluoroethylene carbonate nor chloroethylene carbonate and increasing the amount of ethylene carbonate in conformity therewith and then evaluated for physical properties. The obtained results are shown in Table 1.

TABLE 1
No polymer compound

| | | | | Fluorinated cyclic | Expansion rate of change in | |
|---|---|---|---|---|---|---|
| | | | | carbonate/chlorinated | thickness of battery at the | Discharge capacity |
| | FEC | DFEC | CEC | cyclic carbonate | time of high-temperature | retention rate after |
| | (% by mass) | (% by mass) | (% by mass) | (mass ratio) | storage (%) | 300 cycles (%) |
| Example 1-1 | 0.1 | 0 | 0.1 | 1/1 | 31.3 | 81.7 |
| Comparative | 0.2 | 0 | 0 | — | 38.4 | 81.8 |
| Example 1-1 | | | | | | |
| Example 1-2 | 0.5 | 0 | 0.1 | 5/1 | 32.9 | 82.2 |
| Example 1-3 | 0.3 | 0 | 0.3 | 1/1 | 19.4 | 81.8 |
| Example 1-4 | 0.2 | 0 | 0.4 | 1/2 | 15.5 | 81.1 |
| Comparative | 0.6 | 0 | 0 | — | 38.7 | 82.3 |
| Example 1-2 | | | | | | |
| Example 1-5 | 0.9 | 0 | 0.1 | 9/1 | 34.9 | 82.9 |
| Example 1-6 | 0.8 | 0 | 0.2 | 4/1 | 27.9 | 82.8 |
| Example 1-7 | 0.5 | 0 | 0.5 | 1/1 | 20.5 | 82.1 |
| Example 1-8 | 0.4 | 0 | 0.6 | 2/3 | 16.4 | 81.3 |
| Comparative | 1 | 0 | 0 | — | 41 | 83 |
| Example 1-3 | | | | | | |
| Example 1-9 | 1.2 | 0 | 0.4 | 3/1 | 35.1 | 82 |
| Example 1-10 | 0.8 | 0 | 0.8 | 1/1 | 32.8 | 81.6 |
| Example 1-11 | 0.7 | 0 | 0.9 | 7/9 | 26.2 | 81 |
| Comparative | 1.6 | 0 | 0 | — | 44.5 | 82.7 |
| Example 1-4 | | | | | | |
| Example 1-12 | 1 | 0 | 1 | 1/1 | 36.4 | 81.6 |
| Example 1-13 | 1.1 | 0 | 1.1 | 1/1 | 38.2 | 81.4 |
| Example 1-14 | 0 | 0.3 | 0.1 | 3/1 | 34.5 | 82.3 |
| Example 1-15 | 0 | 0.3 | 0.3 | 1/1 | 27.6 | 81.6 |
| Example 1-16 | 0 | 0.2 | 0.4 | 1/2 | 18.6 | 81.2 |
| Comparative | 0 | 0.6 | 0 | — | 43.1 | 82.9 |
| Example 1-5 | | | | | | |
| Comparative | 0 | 0 | 0 | — | 36.9 | 81.5 |
| Example 1-6 | | | | | | |

FEC: Fluoroethylene carbonate,
DFEC: Difluoroethylene carbonate,
CEC: Chloroethylene carbonate

As shown in Table 1, in Examples 1-1 to 1-16 containing two kinds of halogenated cyclic carbonates containing a different halogen element from each other (fluoroethylene carbonate or difluoroethylene carbonate and chloroethylene carbonate) in the non-aqueous electrolytic solution, the change in the thickness of the battery at the time of storage at 90° C. for 4 hours reduced as compared with Comparative Examples 1-1 to 1-5 not containing chloroethylene carbonate in the non-aqueous electrolytic solution, and Comparative Example 1-6 not adding any halogenated cyclic carbonate in the non-aqueous electrolytic solution, and the discharge capacity retention rate was favorably kept. That is, it was noted that by adding two kinds of halogenated cyclic carbonates containing a different halogen element from each other, the change in the thickness of the battery at the time of high-temperature storage can be suppressed while favorably keeping the discharge capacity retention rate.

Also, in Examples 1-4, 1-8, 1-11 and 1-16 in which the ratio of the chlorinated cyclic carbonate (chloroethylene carbonate) in the non-aqueous electrolytic solution is larger than that of the fluorinated cyclic carbonate (fluoroethylene carbonate or difluoroethylene carbonate), the discharge capacity retention rate was lowered as compared with each of Examples 1-2 and 1-3, Examples 1-5 to 1-7, Examples 1-9 and 1-10 and Examples 1-14 and 1-15. It was noted from this matter that the mass ratio of the fluorinated cyclic carbonate to the chlorinated cyclic carbonate in the non-aqueous electrolytic solution is preferably from 1/1 to 1/10.

Furthermore, in Example 1-13 in which the total sum of fluoroethylene carbonate and chloroethylene carbonate is more than 2% by mass, the change in the thickness of the battery at the time of storage at 90° C. for 4 hours increased as compared with Example 1-9, and the discharge capacity retention rate at the time of repetition of constant-current discharge of 300 times was lowered as compared with Example 1-9. That is, it was noted that the content of the halogenated cyclic carbonates in the non-aqueous electrolytic solution is preferably not more than 2% by mass.

### Examples 2-1 to 2-16 and Comparative Examples 2-1 to 2-6

### Example 2-1

A laminate type battery was prepared in the same manner as in Example 1-1, except for using a separator having a thickness of 7 μm and having 2 μm of polyvinylidene fluoride coated on the both surfaces thereof and then evaluated for physical properties. The obtained results are shown in Table 2.

### Examples 2-2, 2-3, 2-5 to 2-7, 2-9, 2-10 and 2-12

Laminate type batteries were prepared in the same manner as in Example 2-1, except for changing the ratio of fluoroethylene carbonate to chloroethylene carbonate in the non-aqueous electrolytic solution as shown in Table 2 and increasing or decreasing the amount of ethylene carbonate in conformity therewith and then evaluated for physical properties. The obtained results are shown in Table 2.

### Examples 2-4, 2-8 and 2-11

Laminate type batteries were prepared in the same manner as in Example 2-1, except for making the ratio of chloroethylene carbonate larger than that of fluoroethylene carbonate in the non-aqueous electrolytic solution and then evaluated for physical properties. The obtained results are shown in Table 2.

### Example 2-13

A laminate type battery was prepared in the same manner as in Example 2-1, except for regulating the total sum of fluoroethylene carbonate and chloroethylene carbonate in the non-aqueous electrolytic solution at 2% by mass or more and then evaluated for physical properties. The obtained results are shown in Table 2.

### Examples 2-14 and 2-15

Laminate type batteries were prepared in the same manner as in Example 2-1, except for mixing difluoroethylene carbonate in place of fluoroethylene carbonate with chloroethylene carbonate in a ratio as shown in Table 2 in the non-aqueous electrolytic solution and then evaluated for physical properties. The obtained results are shown in Table 2.

### Example 2-16

A laminate type battery was prepared in the same manner as in Example 2-14, except for making the ratio of chloroethylene carbonate larger than that of difluoroethylene carbonate in the non-aqueous electrolytic solution and then evaluated for physical properties. The obtained results are shown in Table 2.

### Comparative Examples 2-1 to 2-4

Laminate type batteries were prepared in the same manner as in Example 2-1, except for not mixing chloroethylene carbonate in the non-aqueous electrolytic solution and then evaluated for physical properties. The obtained results are shown in Table 2.

### Comparative Example 2-5

A laminate type battery was prepared in the same manner as in Example 2-14, except for not mixing chloroethylene carbonate in the non-aqueous electrolytic solution and changing the concentration of difluoroethylene carbonate and then evaluated for physical properties. The obtained results are shown in Table 2.

### Comparative Example 2-6

A laminate type battery was prepared in the same manner as in Example 2-1, except for adding neither fluoroethylene carbonate nor chloroethylene carbonate and increasing the amount of ethylene carbonate in conformity therewith and then evaluated for physical properties. The obtained results are shown in Table 2.

TABLE 2
Polymer compound: Polyvinylidene fluoride

| | | | | Fluorinated cyclic | Expansion rate of change in | |
|---|---|---|---|---|---|---|
| | | | | carbonate/chlorinated | thickness of battery at the | Discharge capacity |
| | FEC | DFEC | CEC | cyclic carbonate | time of high-temperature | retention rate after |
| | (% by mass) | (% by mass) | (% by mass) | (mass ratio) | storage (%) | 300 cycles (%) |
| Example 2-1 | 0.1 | 0 | 0.1 | 1/1 | 20.9 | 80.5 |
| Comparative | 0.2 | 0 | 0 | — | 25.6 | 80.6 |
| Example 2-1 | | | | | | |
| Example 2-2 | 0.5 | 0 | 0.1 | 5/1 | 21.9 | 81 |
| Example 2-3 | 0.3 | 0 | 0.3 | 1/1 | 12.9 | 80.6 |
| Example 2-4 | 0.2 | 0 | 0.4 | 1/2 | 10.3 | 79.9 |
| Comparative | 0.6 | 0 | 0 | — | 25.8 | 81.1 |
| Example 2-2 | | | | | | |
| Example 2-5 | 0.9 | 0 | 0.1 | 9/1 | 23.3 | 81.7 |
| Example 2-6 | 0.8 | 0 | 0.2 | 4/1 | 18.6 | 81.6 |
| Example 2-7 | 0.5 | 0 | 0.5 | 1/1 | 13.7 | 80.9 |
| Example 2-8 | 0.4 | 0 | 0.6 | 2/3 | 10.9 | 80.1 |
| Comparative | 1 | 0 | 0 | — | 27.3 | 81.8 |
| Example 2-3 | | | | | | |
| Example 2-9 | 1.2 | 0 | 0.4 | 3/1 | 23.4 | 80.8 |
| Example 2-10 | 0.8 | 0 | 0.8 | 1/1 | 21.9 | 80.4 |
| Example 2-11 | 0.7 | 0 | 0.9 | 7/9 | 17.5 | 79.8 |
| Comparative | 1.6 | 0 | 0 | — | 29.7 | 81.5 |
| Example 2-4 | | | | | | |
| Example 2-12 | 1 | 0 | 1 | 1/1 | 24.3 | 80.4 |
| Example 2-13 | 1.1 | 0 | 1.1 | 1/1 | 25.5 | 80.2 |
| Example 2-14 | 0 | 0.3 | 0.1 | 3/1 | 23 | 81.1 |
| Example 2-15 | 0 | 0.3 | 0.3 | 1/1 | 18.4 | 80.4 |
| Example 2-16 | 0 | 0.2 | 0.4 | 1/2 | 12.4 | 80 |
| Comparative | 0 | 0.6 | 0 | — | 28.7 | 81.7 |
| Example 2-5 | | | | | | |
| Comparative | 0 | 0 | 0 | — | 24.6 | 80.3 |
| Example 2-6 | | | | | | |

FEC: Fluoroethylene carbonate,
DFEC: Difluoroethylene carbonate,
CEC: Chloroethylene carbonate

As shown in Table 2, in Examples 2-1 to 2-16 each using a non-aqueous electrolytic solution composed of a mixture of two kinds of halogenated cyclic carbonates containing a different halogen element from each other and a polymer compound (polyvinylidene fluoride) which is swollen by the non-aqueous electrolytic solution, the change in the thickness of the battery at the time of storage at 90° C. for 4 hours reduced as compared with each of Examples 1-1 to 1-16 not containing polyvinylidene fluorine in the non-aqueous electrolytic solution. That is, it was noted that by using a polymer compound which is swollen by the non-aqueous electrolytic solution as well as two kinds of halogenated cyclic carbonates containing a different halogen element from each other, an effect for suppressing the battery expansion at the time of high-temperature storage is enhanced.

Also, in Examples 2-1 to 2-16 containing two kinds of halogenated cyclic carbonates containing a different halogen element from each other (fluoroethylene carbonate or difluoroethylene carbonate and chloroethylene carbonate) in the non-aqueous electrolytic solution, the change in the thickness of the battery at the time of storage at 90° C. for 4 hours reduced as compared with Comparative Examples 2-1 to 2-5 not containing chloroethylene carbonate in the non-aqueous electrolytic solution, and Comparative Example 2-6 not adding any halogenated cyclic carbonate in the non-aqueous electrolytic solution, and the discharge capacity retention rate was favorably kept. That is, it was noted that similar to the case of not adding a polymer compound which is swollen by the non-aqueous electrolytic solution in the non-aqueous electrolytic solution, even in the case of adding the polymer compound which is swollen by the non-aqueous electrolytic solution in the non-aqueous electrolytic solution, by adding two kinds of halogenated cyclic carbonates containing a different halogen element from each other, the change in the thickness of the battery at the time of high-temperature storage can be suppressed while favorably keeping the discharge capacity retention rate.

In Examples 2-4, 2-8, 2-11 and 2-16 in which the ratio of the chlorinated cyclic carbonate (chloroethylene carbonate) in the non-aqueous electrolytic solution is larger than that of the fluorinated cyclic carbonate (fluoroethylene carbonate or difluoroethylene carbonate), the discharge capacity retention rate was lowered as compared with each of Examples 2-2 and 2-3, Examples 2-5 to 2-7, Examples 2-9 and 2-10 and Examples 2-14 and 2-15. It was noted from this matter that similar to the case of not adding a polymer compound which is swollen by the non-aqueous electrolytic solution in the non-aqueous electrolytic solution, even in the case of adding the polymer compound which is swollen by the non-aqueous electrolytic solution in the non-aqueous electrolytic solution, the mass ratio of the fluorinated cyclic carbonate to the chlorinated cyclic carbonate in the non-aqueous electrolytic solution is preferably from 1/1 to 1/10.

Furthermore, in Example 2-13 in which the total sum of fluoroethylene carbonate and chloroethylene carbonate is more than 2% by mass, the change in the thickness of the battery at the time of storage at 90° C. for 4 hours increased as compared with Example 2-9, and the discharge capacity retention rate at the time of repetition of constant-current discharge of 300 times was lowered as compared with Example 2-9. That is, it was noted that similar to the case of not adding a polymer compound which is swollen by the non-aqueous electrolytic solution in the non-aqueous electrolytic solution, even in the case of adding the polymer compound which is swollen by the non-aqueous electrolytic solution in the non-aqueous electrolytic solution, the content of the halogenated cyclic carbonates in the non-aqueous electrolytic solution is preferably not more than 2% by mass.

### Examples 3-1 to 3-4 and Comparative Examples 3-1 to 3-4

### Examples 3-1 to 3-4

Laminate type batteries were prepared in the same manner as in Example 1-6, except for mixing LiBF₄ in an amount as shown in Table 3 in the non-aqueous electrolytic solution and then evaluated for physical properties. The obtained results are shown in Table 3.

### Comparative Example 3-1

A laminate type battery was prepared in the same manner as in Example 3-1, except for not mixing chloroethylene carbonate in the non-aqueous electrolytic solution and then evaluated for physical properties. The obtained results are shown in Table 3.

### Comparative Example 3-2

A laminate type battery was prepared in the same manner as in Example 3-1, except for not mixing fluoroethylene carbonate in the non-aqueous electrolytic solution and then evaluated for physical properties. The obtained results are shown in Table 3.

### Comparative Example 3-3

A laminate type battery was prepared in the same manner as in Example 3-2, except for not mixing LiBF₄ in the non-aqueous electrolytic solution and then evaluated for physical properties. The obtained results are shown in Table 3.

### Comparative Example 3-4

A laminate type battery was prepared in the same manner as in Example 3-1, except for adding neither fluoroethylene carbonate nor chloroethylene carbonate and then evaluated for physical properties. The obtained results are shown in Table 3.

TABLE 3
No polymer compound

| | | | | | | Expansion rate of | |
|---|---|---|---|---|---|---|---|
| | | | | Fluorinated cyclic | | change in thickness | |
| | | | | carbonate/chlorinated | | of battery at the time | Discharge capacity |
| | FEC | CEC | LiBF₄ | cyclic carbonate | Composition of main | of high-temperature | retention rate after |
| | (% by mass) | (% by mass) | (% by mass) | (mass ratio) | solvent (mass ratio) | storage (%) | 300 cycles (%) |
| Example 1-6 | 0.8 | 0.2 | 0 | 4/1 | EC/EMC = 4/6 | 27.9 | 82.8 |
| Example 3-1 | 0.8 | 0.2 | 0.2 | 4/1 | EC/EMC = 4/6 | 20.3 | 83.3 |
| Example 3-2 | 0.8 | 0.2 | 0.05 | 4/1 | EC/EMC = 4/6 | 25.1 | 83.0 |
| Example 3-3 | 0.8 | 0.2 | 0.5 | 4/1 | EC/EMC = 4/6 | 19.2 | 82.9 |
| Example 3-4 | 0.8 | 0.2 | 0.2 | 4/1 | EC/EMC/DEC = 4/4/2 | 14.8 | 82.5 |
| Comparative | 1 | 0 | 0.2 | — | EC/EMC = 4/6 | 35.4 | 83.5 |
| Example 3-1 | | | | | | | |
| Comparative | 1 | 0 | 0 | — | EC/EMC = 4/6 | 41.0 | 83.0 |
| Example 1-3 | | | | | | | |
| Comparative | 0 | 1 | 0.2 | — | EC/EMC = 4/6 | 10.6 | 48.6 |
| Example 3-2 | | | | | | | |
| Comparative | 0 | 1 | 0 | — | EC/EMC = 4/6 | 12.3 | 47.2 |
| Example 3-3 | | | | | | | |
| Comparative | 0 | 0 | 0.2 | — | EC/EMC = 4/6 | 31.9 | 82.0 |
| Example 3-4 | | | | | | | |
| Comparative | 0 | 0 | 0 | — | EC/EMC = 4/6 | 36.9 | 81.5 |
| Example 1-6 | | | | | | | |

FEC: Fluoroethylene carbonate,
CEC: Chloroethylene carbonate,
EC: Ethylene carbonate,
EMC: Ethylmethyl carbonate,
DEC: Diethylene carbonate

As shown in Table 3, in all of Examples 3-1 to 3-4 each containing lithium tetrafluoroborate in the non-aqueous electrolytic solution, the change in the thickness of the battery at the time of storage at 90° C. for 4 hours reduced as compared with Example 1-6 not containing lithium tetrafluoroborate, and the discharge capacity retention rate was favorably kept. Also, it was noted that the content of lithium tetrafluoroborate in the non-aqueous electrolytic solution is preferably from 0.05 to 0.5% by mass. Furthermore, in Example 3-4 in which diethylene carbonate was added as the main solvent, the change in the thickness of the battery at the time of storage at 90° C. for 4 hours more reduced as compared with Example 3-1, and the discharge capacity retention rate was favorably kept.

On the other hand, in Comparative Examples 3-1, 1-3, 3-4 and 1-6 not containing chloroethylene carbonate, the change in the thickness of the battery at the time of storage at 90° C. for 4 hours could not be sufficiently suppressed. Also, in Comparative Examples 3-2 and 3-3 not containing fluoroethylene carbonate, though the change in the thickness of the battery at the time of storage at 90° C. for 4 hours reduced, the discharge capacity retention rate could not be favorably kept.

### Examples 4-1 to 4-4 and Comparative Examples 4-1 to 4-4

### Examples 4-1 to 4-4

Laminate type batteries were prepared in the same manner as in Example 2-6, except for using a separator having a thickness of 7 μm and having 2 μm of polyvinylidene fluoride coated on the both surfaces thereof and mixing LiBF₄ in an amount as shown in Table 4 in the non-aqueous electrolytic solution, and then evaluated for physical properties. The obtained results are shown in Table 4.

### Comparative Example 4-1

A laminate type battery was prepared in the same manner as in Example 4-1, except for not mixing chloroethylene carbonate in the non-aqueous electrolytic solution and then evaluated for physical properties. The obtained results are shown in Table 4.

### Comparative Example 4-2

A laminate type battery was prepared in the same manner as in Example 4-1, except for not mixing fluoroethylene carbonate in the non-aqueous electrolytic solution and then evaluated for physical properties. The obtained results are shown in Table 4.

### Comparative Example 4-3

A laminate type battery was prepared in the same manner as in Example 4-2, except for not mixing LiBF₄ in the non-aqueous electrolytic solution and then evaluated for physical properties. The obtained results are shown in Table 4.

### Comparative Example 4-4

A laminate type battery was prepared in the same manner as in Example 4-1, except for adding neither fluoroethylene carbonate nor chloroethylene carbonate and then evaluated for physical properties. The obtained results are shown in Table 4.

TABLE 4
Polymer compound: Polyvinylidene fluoride

| | | | | | | Expansion rate of | |
|---|---|---|---|---|---|---|---|
| | | | | Fluorinated cyclic | | change in thickness of | |
| | | | | carbonate/chlorinated | | battery at the time of | Discharge capacity |
| | FEC | CEC | LiBF₄ | cyclic carbonate | Composition of main | high-temperature | retention rate after |
| | (% by mass) | (% by mass) | (% by mass) | (mass ratio) | solvent (mass ratio) | storage (%) | 300 cycles (%) |
| Example 2-6 | 0.8 | 0.2 | 0 | 4/1 | EC/EMC = 4/6 | 13.5 | 82.1 |
| Example 4-1 | 0.8 | 0.2 | 0.2 | 4/1 | EC/EMC = 4/6 | 16.7 | 81.8 |
| Example 4-2 | 0.8 | 0.2 | 0.05 | 4/1 | EC/EMC = 4/6 | 12.8 | 81.7 |
| Example 4-3 | 0.8 | 0.2 | 0.5 | 4/1 | EC/EMC = 4/6 | 9.9 | 81.3 |
| Example 4-4 | 0.8 | 0.2 | 0.2 | 4/1 | EC/EMC/DEC = 4/4/2 | 18.6 | 81.6 |
| Comparative | 1 | 0 | 0.2 | — | EC/EMC = 4/6 | 23.6 | 82.3 |
| Example 4-1 | | | | | | | |
| Comparative | 1 | 0 | 0 | — | EC/EMC = 4/6 | 27.3 | 81.8 |
| Example 2-3 | | | | | | | |
| Comparative | 0 | 1 | 0.2 | — | EC/EMC = 4/6 | 7.1 | 47.9 |
| Example 4-2 | | | | | | | |
| Comparative | 0 | 1 | 0 | — | EC/EMC = 4/6 | 8.2 | 46.5 |
| Example 4-3 | | | | | | | |
| Comparative | 0 | 0 | 0.2 | — | EC/EMC = 4/6 | 21.3 | 80.8 |
| Example 4-4 | | | | | | | |
| Comparative | 0 | 0 | 0 | — | EC/EMC = 4/6 | 24.6 | 80.3 |
| Example 2-6 | | | | | | | |

FEC: Fluoroethylene carbonate,
CEC: Chloroethylene carbonate,
EC: Ethylene carbonate,
EMC: Ethylmethyl carbonate,
DEC: Diethylene carbonate

As shown in Table 4, in Examples 4-1 to 4-4 each using a non-aqueous electrolytic solution composed of a mixture of two kinds of halogenated cyclic carbonates containing a different halogen element from each other and a polymer compound (polyvinylidene fluoride) which is swollen by the non-aqueous electrolytic solution, the change in the thickness of the battery at the time of storage at 90° C. for 4 hours reduced as compared with each of Examples 3-1 to 3-4 not containing polyvinylidene fluorine in the non-aqueous electrolytic solution. That is, it was noted that by using a polymer compound which is swollen by the non-aqueous electrolytic solution as well as two kinds of halogenated cyclic carbonates containing a different halogen element from each other, an effect for suppressing battery expansion at the time of high-temperature storage is enhanced.

Also, in all of Examples 4-1 to 4-4 each containing lithium tetrafluoroborate in the non-aqueous electrolytic solution, the change in the thickness of the battery at the time of storage at 90° C. for 4 hours reduced as compared with Example 2-6 not containing lithium tetrafluoroborate, and the discharge capacity retention rate was favorably kept. Also, it was noted that the content of lithium tetrafluoroborate in the non-aqueous electrolytic solution is preferably from 0.05 to 0.5% by mass. Furthermore, in Example 4-4 in which diethyl carbonate was added as the main solvent, the change in the thickness of the battery at the time of storage at 90° C. for 4 hours more reduced as compared with Example 4-1, and the discharge capacity retention rate was favorably kept.

On the other hand, in Comparative Examples 4-1, 2-3, 4-4 and 2-6 not containing chloroethylene carbonate, the change in the thickness of the battery at the time of storage at 90° C. for 4 hours could not be sufficiently suppressed. Also, in Comparative Examples 4-2 and 4-3 not containing fluoroethylene carbonate, though the change in the thickness of the battery at the time of storage at 90° C. for 4 hours reduced, the discharge capacity retention rate could not be favorably kept.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A non-aqueous electrolytic solution battery comprising:
a positive electrode;
a negative electrode and
an electrolytic solution, wherein
the non-aqueous electrolytic solution contains two kinds of halogenated cyclic carbonates containing a different halogen element from each other.

2. The non-aqueous electrolytic solution battery according to claim 1, wherein the halogenated cyclic carbonates are a fluorinated cyclic carbonate and a chlorinated cyclic carbonate.

3. The non-aqueous electrolytic solution battery according to claim 2, wherein a mass ratio of the fluorinated cyclic carbonate to the chlorinated cyclic carbonate in the non-aqueous electrolytic solution is from 1/1 to 1/10.

4. The non-aqueous electrolytic solution battery according to claim 2, wherein the fluorinated cyclic carbonate is fluoroethylene carbonate, and the chlorinated cyclic carbonate is chloroethylene carbonate.

5. The non-aqueous electrolytic solution battery according to claim 1, further containing lithium tetrafluoroborate.

6. The non-aqueous electrolytic solution battery according to claim 5, wherein the content of lithium tetrafluoroborate in the non-aqueous electrolytic solution is from 0.05 to 0.5% by mass.

7. The non-aqueous electrolytic solution battery according to claim 1, containing a polymer compound which is swollen by the non-aqueous electrolytic solution.

8. The non-aqueous electrolytic solution battery according to claim 7, wherein the polymer compound is polyvinylidene fluoride.

9. The non-aqueous electrolytic solution battery according to claim 1, wherein the positive electrode, the negative electrode and the non-aqueous electrolytic solution are contained in an exterior member composed of a laminated film.

10. A non-aqueous electrolytic solution composition comprising two kinds of halogenated cyclic carbonates containing a different halogen element from each other.

11. The non-aqueous electrolytic solution composition according to claim 10, wherein the halogenated cyclic carbonates are a fluorinated cyclic carbonate and a chlorinated cyclic carbonate.

12. The non-aqueous electrolytic solution composition according to claim 11, wherein a mass ratio of the fluorinated cyclic carbonate to the chlorinated cyclic carbonate in the non-aqueous electrolytic solution is from 1/1 to 1/10.

13. The non-aqueous electrolytic solution composition according to claim 11, wherein the fluorinated cyclic carbonate is fluoroethylene carbonate, and the chlorinated cyclic carbonate is chloroethylene carbonate.

14. The non-aqueous electrolytic solution composition according to claim 10, further containing lithium tetrafluoroborate.

15. The non-aqueous electrolytic solution composition according to claim 14, wherein the content of lithium tetrafluoroborate in the non-aqueous electrolytic solution is from 0.05 to 0.5% by mass.
